(19) United States
(12) Patent Application Publication
(10) Pub. No.: US 2016/0213169 A1
(43) Pub. Date: Jul. 28, 2016

(54) PRODUCT DISPLAY DEVICE

(71) Applicant: COTTONWOOD APPAREL, LLC, Lakeland, FL (US)

(72) Inventors: Chadwick Lee Kennedy, Lakeland, FL (US); James J. BATTISTA, JR., Orlando, FL (US)

(21) Appl. No.: 14/607,122

(22) Filed: Jan. 28, 2015

(51) Int. Cl. A47F 7/02; B67B 7/16; A47F 5/00

(52) U.S. Cl. CPC A47F 7/02; A47F 5/0006; B67B 7/16

(57) ABSTRACT

A product display device for an eyeglass retainer is provided including a body having an upper portion, a lower portion, and a mid-section. The lower portion includes a first side and a second side, wherein the first side and the second side of the lower portion each connect to a respective first side and second side of the mid-section forming an opening between the lower portion and the mid-section. The mid-section includes one or more edge portions extending into the opening, the one or more edge portions are configured to associate with an inferior surface of a bottle cap. The product display device may include two or more prongs, spaced from one another, and depending from the body. Each of the two or more prongs includes a first end and a second end, wherein the first end of each prong associates with the body, and the second end of each prong is configured to retain an end of an eyeglass retainer.

### BACKGROUND OF THE INVENTION

Embodiments of the present invention relate to a device for displaying a product. Storage, retention, and display for convenient examination and selection of eyeglass retainers presents a problem which has not been adequately solved heretofore. In retail settings, eyeglass retainers are typically found in a jar or bowl on a counter top, bunched together or stacked on top of one another often causing entangling of the eyeglass retainers. Lack of an adequate display prevents easy viewing of the eyeglass retainers by a customer. The lack of an effective display of these eyeglass retainers can hamper sales of the retainers. Consequently, a need exists for an effective product display device for an eyeglass retainer.

### SUMMARY

In one embodiment, a product display device for an eyeglass retainer is provided, wherein the product display device includes a body having an upper portion, a lower portion, and a mid-section. The lower portion includes a first side and a second side, wherein the first side and the second side of the lower portion each connect to a respective first side and second side of the mid-section forming an opening between the lower portion and the mid-section. The mid-section may include one or more edge portions extending into the opening, the one or more edge portions being configured to associate with an inferior surface of a bottle cap. The product display device may include two or more prongs, spaced from one another, depending from the body. Each of the two or more prongs may include a first end and a second end, wherein the first end of each prong associates with the body, and the second end of each prong is configured to retain an end of an eyeglass retainer.

In another embodiment, a product display device is provided. The product display device may include a body having an upper portion, a lower portion, and a mid-section. The lower portion includes a first side and a second side, wherein the first side and the second side of the lower portion connects to a respective first side and second side of the mid-section, forming an opening between the lower portion and the mid-section. The product display device may include two or more prongs depending from the mid-section, and extending into the opening forming one or more edge portions being configured to associate with an inferior surface of a bottle cap to lift said bottle cap from a bottle. Each of the two or more prongs may include a first end and a second end, wherein the first end of each prong associates with the mid-section, and the second end of each prong is configured to retain an end of an eyeglass retainer.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 is a perspective view of an embodiment of a product display device.

FIG. 2 is a front view of the embodiment of the product display device of FIG. 1.

FIG. 3 is a back view of the embodiment of the product display device of FIG. 1.

FIG. 4 is a front view of an embodiment of a product display device and an eyeglass retainer.

FIG. 5 is a front view of a product display device suspended on a protrusion displaying an eyeglass retainer associated therewith.

FIG. 6 is a front view of another embodiment of a product display device.

### DETAILED DESCRIPTION

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained.

While certain embodiments of the present invention have been shown and described herein, such embodiments are provided by way of example only. Numerous variations, changes and substitutions will occur to those of skill in the art without departing from the invention herein. Accordingly, it is intended that the invention be limited only by the spirit and scope of the appended claims.

The inventors have discovered a novel product display device which may also serve as a bottle cap remover in some embodiments, as described in greater detail herein. Embodiments of the product display device provided herein may be for retaining and displaying eyeglass retainers so that they can be easily viewed and selected for purchase by a potential consumer, for example. These product display device embodiments may provide dual functionality as a bottle cap remover. Consequently, non-limiting embodiments of the invention disclosed herein may include a novel combination product display and bottle cap remover device.

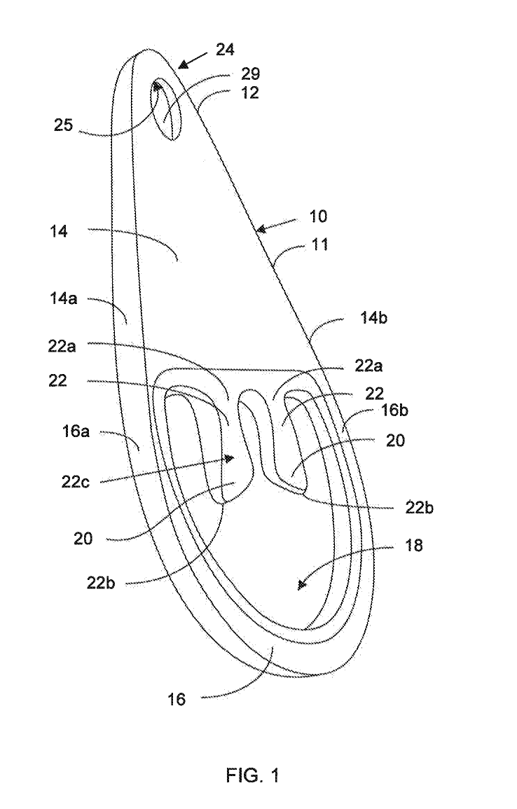

With respect to FIG. 1, there is provided a perspective view of an embodiment of a product display device 10 having a body 11 with an upper portion 12, a mid-section 14, and a lower portion 16. The lower portion includes a first side 16a and a second side 16b which associates with a first side 14a of the mid-section and a second side 14b of the mid-section, respectively, to form an opening 18 between the mid-section 14 and the lower portion 16 of the body 11 of the device 10. The body 11 is shown as having a tear drop shape in the embodiment provided in FIG. 1, however, the body 11 may be formed of any shape including, but not limited to circular, square, hexagonal, or any other shape known to those skilled in the art which would provide the same functionality as described herein.

The mid-section 14 may include a one or more edge portions 20 extending from a portion thereof into the opening 18. In a non-limiting embodiment, the one or more edge portions 20 may include a beveled edge, or any other surface or configuration enabling engagement with an inferior surface of a bottle cap. In the non-limiting embodiment shown in FIG. 1, two prongs 22 depend from the mid-section 14 and extend into the opening 18, wherein the two prongs 22 include the one or more edge portions 20. The one or more edge portions 20 may be configured to associate with an inferior surface of the bottle cap in an embodiment, providing a surface for engaging an edge portion of the inferior surface of the bottle cap to enable removal of the bottle cap from a bottle. To remove a bottle cap from a bottle using the device 10, the one or more edge portions 20 may be pressed against an inferior edge surface of the bottle cap such that the lower portion 16 bears downwardly against an upper portion of the bottle cap. Movement of the upper portion 12 of the device 10 in an upward direction bends the edge of the bottle cap allowing any seal between the bottle cap and the bottle to be broken and the bottle cap to be removed from the bottle.

The prongs 22, as shown in FIG. 1 may be spaced apart from one another, each prong 22 having a first end 22a and a second end 22b. The first end 22a may be associated with the body 11, and the second end 22b may extend there from, wherein the second end 22b is configured to retain an end 27, 28 of an eyeglass retainer 26 (eyeglass retainer not shown in FIG. 1).

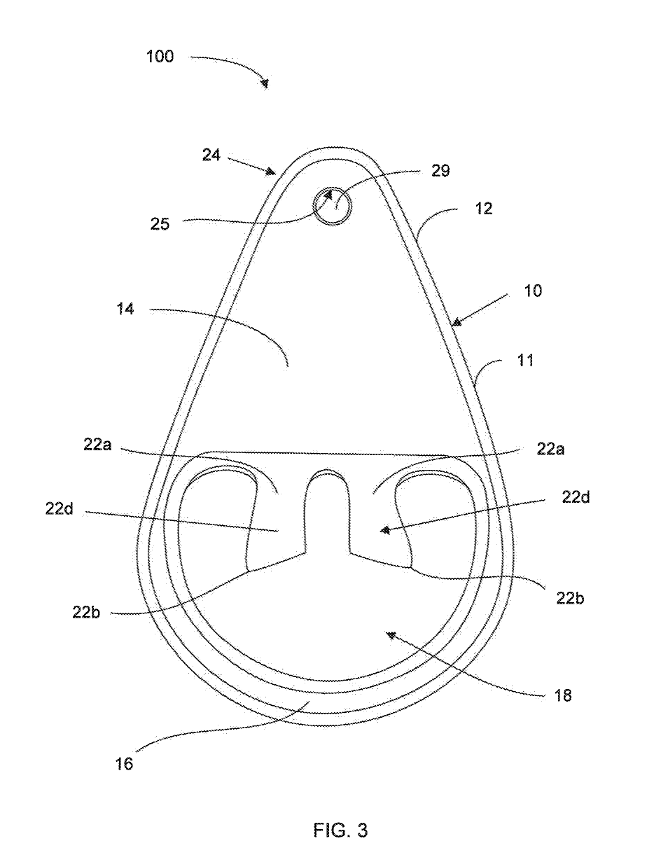

The two or more prongs 22 may include a first side 22c and a second side 22d (second side shown in FIG. 3). As demonstrated in the non-limiting embodiment of FIG. 1, the two or more prongs 22 may depend from the mid-section 14 of the body 11, however, in other embodiments, the two or more prongs 22 may depend from other portions of the body 11 of the device 10.

The device 10 may further include an attachment component 24 associated with the body 10. The attachment component 24 may be configured to attach to a surface such that the body 10 may be suspended above a horizontal plane, such that a longitudinal axis of the body 10 is transverse to the horizontal plane, and the two or more prongs 22 are each configured to retain an end of an eyeglass retainer 26 (eyeglass retainer not shown in FIG. 26) and suspend the eyeglass retainer 26. The attachment component 24 may include a hooked section 25. In the non-limiting embodiment shown in FIG. 1, the attachment component 24 includes an aperture 29, wherein the aperture forms the hooked section 25. The hooked section 25 is formed by the curved upper edge of the aperture 29 in the embodiment shown herein. The attachment component 24 is disposed in the upper portion 12 of the body 11 of the device 10 in the non-limiting embodiment of the device 10 of FIG. 1, but can be associated with any other portion of the device 10. In the embodiments shown in FIGS. 1-5, the hooked section 25 is part of the aperture 29.

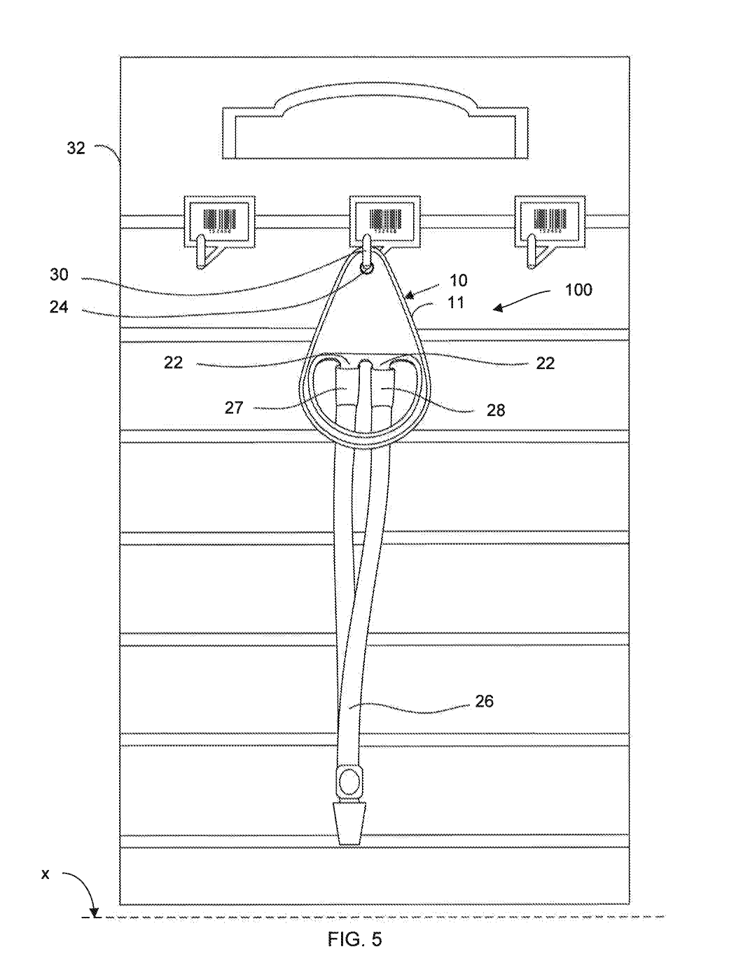

The attachment component 24 may be used to suspend the device 10 above a horizontal plane as aforementioned, and may be configured to receive a protrusion 30 (as shown in FIG. 5), such that the device 10 may be suspended to display an eyeglass retainer 26 (not shown in FIG. 1) that may hang there from. The device 10 is not limited to having an aperture 29 or a hooked section 25. For example, in an alternative non-limiting embodiment, the device 10 may be suspended by way of an adhesive.

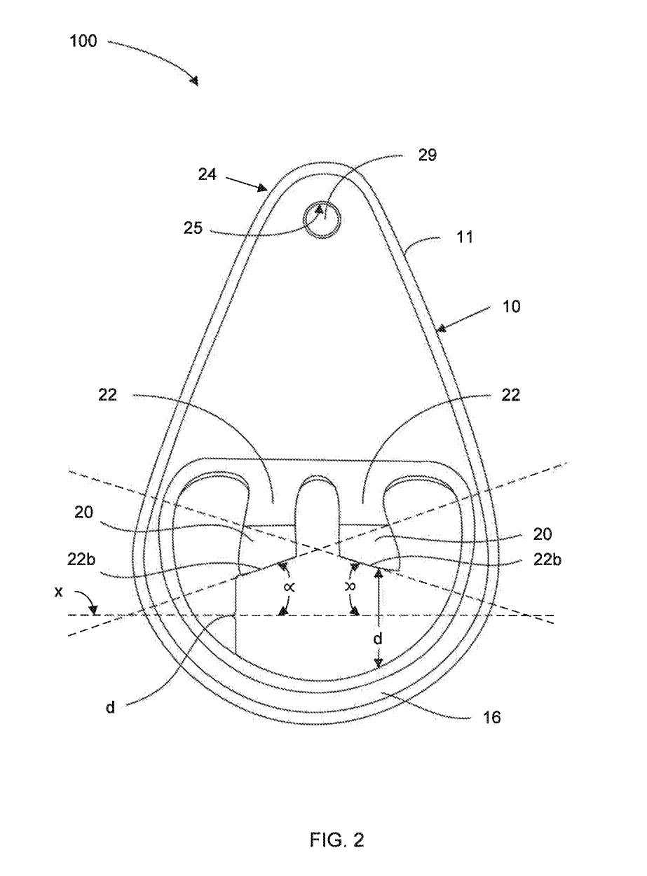

FIG. 2 includes a front side view of the embodiment of the product display device 10 shown in FIG. 1. A horizontal axis (x) is identified for reference in FIG. 2. The body 11 of the device 10 includes the aperture 24 disposed in the upper portion 12 of the body 11 for suspending the device 10 to display an eyeglass retainer 26 (eyeglass retainer not shown in FIG. 2) when attached to the prongs 22. The second ends 22b of the prongs 22 are shaped to create a pitch angle α relative to the horizontal axis (x) as shown in FIG. 2. The shape of the second ends 22b of the prongs 22 may be provided as shown in FIG. 2, for example, such that the second ends 22b of the prongs may associate with a portion of a bottle when the device 10 is used to remove a bottle cap there from. The one or more edge portions 20 of the prongs 22 may be provided to create a contact surface with the inferior portion of the bottle cap to facilitate removal thereof. The pitch angle (a) may vary; however, in a non-limiting embodiment the pitch angle α may include an angle ranging between 10° and 80° relative to a horizontal axis x in one non-limiting embodiment, and preferably an angle between 30° and 50° relative to horizontal axis x in another non-limiting embodiment as shown in FIG. 2. The shape of the second end 22b of the prongs may also vary, and the angular pitch a formed between the second end 22b of the prongs and the lower portion 16 may provide a surface complementary to an outer portion of a bottle neck from which a bottle cap may be removed. The shape of the second ends 22b of the prongs 22 may also be varied to further secure the ends of the eyeglass retainer to the device 10, in a non-limiting embodiment.

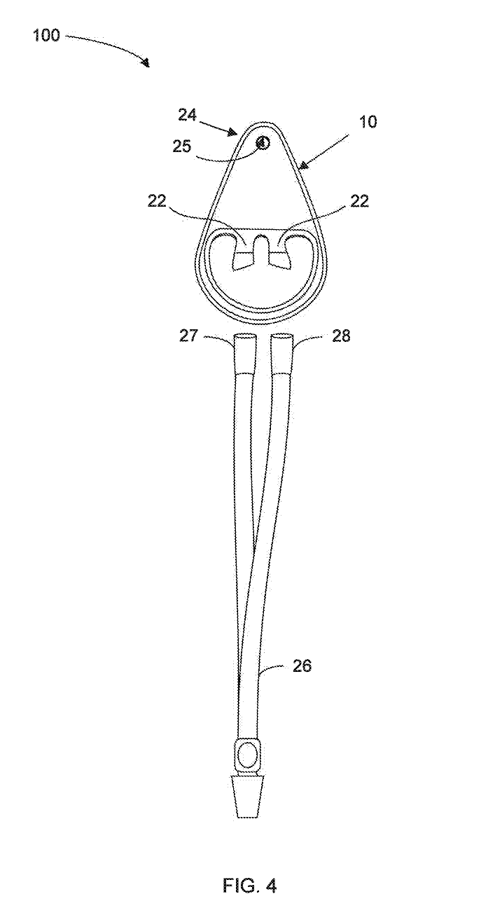

In a further non-limiting embodiment, a distance (d) between the second ends 22b of the two or more prongs 22 and a lower portion 16 of the body 11 of the device 10 may range between 0.5 cm-3.0 cm. The distance (d) provides a space between the prongs 22 and the lower portion 16 such that the second ends 22b of the prongs may abut an inferior portion of the bottle cap and the lower portion 16 may abut the top portion of the bottle cap to compress the top portion of the bottle cap when a portion of a bottle cap is inserted there between for removal from the bottle. The distance (d) also provides a space between the second ends 22b of the prongs 22 such that the ends 27, 28 of the eyeglass retainer 26 can be attached onto the prongs 22 of the device 10 (eyeglass retainer is shown in FIGS. 4-5).

FIG. 3 provides a back view of the product display device 10 embodiment shown in FIGS. 1-2. The body 11 of the device 10 includes an attachment component 24 shown as an aperture 29 with a hooked portion 25. The aperture 29 is shown as disposed in the upper portion 12 of the body 11. The body 11 further includes the mid-section 14, the lower portion 16, and two prongs 22 extending from the mid-section 14 into the opening 18. The first ends 22a of each prong 22 is associated with a portion of the mid-section 14, and the second ends 22b extend into the opening 18. The second side 22d of each prong 22 can be seen in the back view of FIG. 3.

FIG. 4 is a front view of the embodiment of the product display device 10 and an eyeglass retainer 26 disposed there below. The eyeglass retainer 26 includes a first end 27 and a second end 28 wherein each end may be positioned over a respective prong 22 to display the eyeglass retainer 26 on the product display device 10 as shown in FIG. 5. FIG. 5 illustrates the embodiment of the product display device 10 with the eyeglass retainer 26 attached thereto, suspended on a display board 32 having protrusions 30. The aperture 24 may be positioned over a protrusion 30, like a rack arm, on the display board 32 as shown in FIG. 5 to suspend the device 10 such that the two or more prongs 22 extend in a downward direction, and a longitudinal axis of the body 11 of the device 10 is transverse relative to a horizontal plane (x). Suspending the product display device 10 with the eyeglass retainer 26 attached thereto via the eyeglass retainer ends 27, 28 as shown in FIG. 5 allows one to easily view the eyeglass retainer 26.

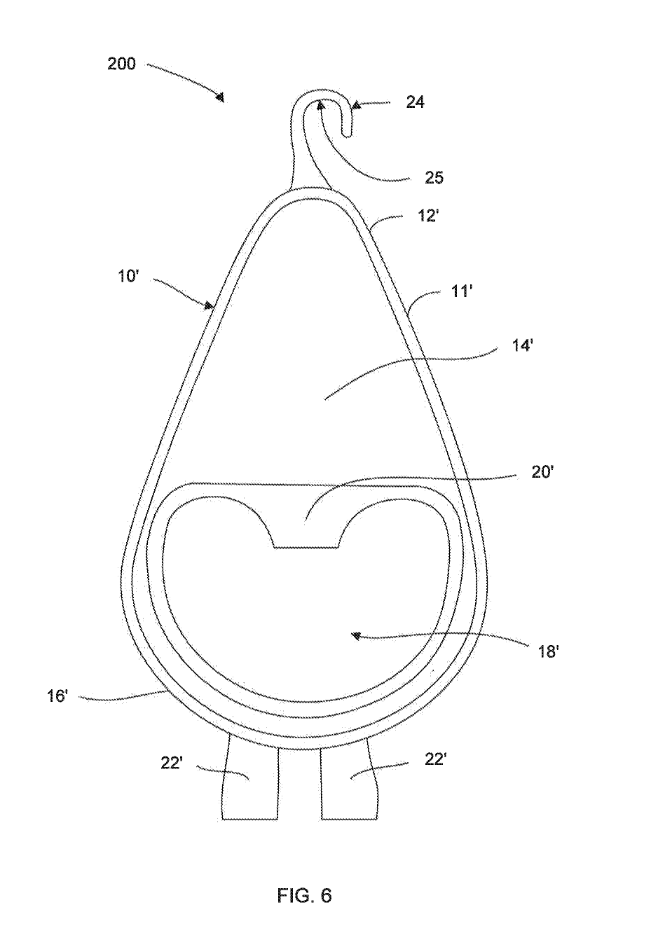

Another embodiment of a product display device 10′ is illustrated in FIG. 6. The non-limiting embodiment of the device 10′ includes a body 11′ having an upper portion 12′, a mid-section 14′ and a lower portion 16′, wherein an edge portion 20′ extends from the mid-section 14′ of the body 11′ into the opening 18′. The edge portion 20′ of the of the product display device 10′ may be associated with an inferior portion of an edge of a bottle cap and may be used to remove a bottle cap from a bottle by pressing the lower portion 16′ onto a top surface portion of the bottle cap and lifting the upper portion 12′ of the device in an upward direction. In the non-limiting embodiment of FIG. 6, two prongs 22′ extend from the lower portion 16′ of the body 11′ and are spaced apart from one another. The two prongs 22′ may be provided for attaching a first and second end 27, 28, respectively, of an eyeglass retainer 26 thereto (eyeglass retainer not shown in FIG. 6) to display the eyeglass retainer, in a non-limiting embodiment. The non-limiting embodiment of the product display device 10′ of FIG. 6 includes an attachment component 24 formed as a hook having a hooked portion 25, wherein the attachment component is associated with the upper portion 12′ of the device 10′.

The terminology used herein is for the purpose of describing particular embodiments only and is not intended to be limiting. As used herein, the singular forms “a,” “an,” and “the” are intended to include the plural forms as well, unless the context clearly indicates otherwise these terms do not denote a limitation of quantity, but rather denote the presence of at least one of the referenced item. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order, quantity or importance, but rather the terms first, second, etc., are used to distinguish one element from another.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

What is claimed is:

1. A product display device for an eyeglass retainer, comprising:
a body comprising an upper portion, a lower portion, and a mid-section, said lower portion comprising a first side and a second side, wherein said first side and said second side of said lower portion connects to a respective first side and second side of the mid-section, forming an opening between the lower portion and the mid-section, wherein said mid-section comprises one or more edge portions extending into the opening, said edge portion configured to associate with an inferior surface of a bottle cap;
two or more prongs depending from the body, said two or more prongs being spaced from one another, each of said two or more prongs comprising a first end and a second end, wherein the first end of each prong associates with the body, and the second end of each prong is configured to retain an end of an eyeglass retainer.

2. The product display device of claim 1, wherein the two or more prongs comprise a first side and a second side, said second ends of said two or more prongs forming the one or more edge portions configured to associate with an inferior surface of a bottle cap.

3. The product display device of claim 2, wherein the two or more prongs depend from the mid-section of the body, said two or more prongs extending into the opening.

4. The product display device of claim 1, wherein the two or more prongs depend from the lower portion of the body, said two or more prongs extending below the body of the device.

5. The product display device of claim 1, further comprising an attachment component associated with the body, wherein said attachment component is configured to attach to a surface such that the body is suspended above a horizontal plane, wherein a longitudinal axis of the body is transverse to the horizontal plane, such that the two or more prongs are configured to retain an eyeglass retainer and suspend said eyeglass retainer.

6. The product display device of claim 5, wherein the attachment component comprises a hooked section.

7. The product display device of claim 6, wherein the attachment component comprises an aperture, said aperture forming the hooked section.

8. The product display device of claim 7, wherein the aperture is configured to receive a protrusion to suspend the device such that the two or more prongs extend in a downward direction, wherein a longitudinal axis of the body is transverse relative to a horizontal plane.

9. The product display device of claim 1, wherein the opening is configured to receive a portion of a cap of a bottle such that the one or more edge portions abut an inferior surface of the cap, and the lower portion of the body can abut a top surface of the cap such that movement of the upper portion of the body in an upward direction toward the cap releases the cap from the bottle.

10. The product display device of claim 3, wherein the opening is configured to receive a portion of a cap of a bottle and wherein the one or more edge portions at the second ends of each of the two or more prongs are configured to abut an inferior portion of an edge of the cap and the lower portion of the body is configured to abut a top surface of the cap, wherein movement of the upper portion of the body in an upward direction toward the cap releases the cap from the bottle.

11. The product display device of claim 3, wherein the second ends of the two or more prongs comprise a pitch angle (a) relative to a horizontal axis (x).

12. A product display device, comprising:
a body comprising an upper portion, a lower portion, and a mid-section, said lower portion comprising a first side and a second side, wherein said first side and said second side of said lower portion connects to a respective first side and second side of the mid-section forming an opening between the lower portion and the mid-section, and said upper portion comprising a generally hooked portion; and
two or more prongs depending from the mid-section and extending into the opening forming one or more edge portions configured to associate with an inferior surface of a bottle cap to lift said bottle cap from a bottle, the two or more prongs being spaced from one another, each of said two or more prongs comprising a first end and a second end, wherein the first end of each of the two or more prongs associates with the mid-section, and the second end of each of the two or more prongs is configured to retain an end of an eyeglass retainer.

13. The product display device of claim 12, wherein the second ends of the two or more prongs each form an angular pitch (α) such that the second ends of the two or more prongs form a surface complementary to an outer portion of a bottle, said one or more edge portions being configured to abut the surface of the bottle against an inferior surface of the bottle cap, wherein when the second ends abut the bottle at the inferior surface of the bottle cap, the opening is configured to receive a portion of the bottle cap, such that the lower portion of the body abuts a top surface of the bottle cap, and movement of the upper portion of the body removes the bottle cap from the bottle.

14. The product display device of claim 13, wherein the angular pitch (α) comprises an angle between 10° and 80°.

15. The product display device of claim 12, wherein a distance between the second ends of the two or more prongs and the lower portion of the body comprises between 0.5 cm-3.0 cm.
